(19) United States
(12) Patent Application Publication
(10) Pub. No.: US 2026/0170040 A1
(43) Pub. Date: Jun. 18, 2026

(54) SUMMARIZING UPDATES TO ELECTRONIC DOCUMENTS USING ARTIFICIAL INTELLIGENCE

(71) Applicant: Google LLC, Mountain View, CA (US)

(72) Inventors: Carlos Tamulonis, Boulder, CO (US); Joshua Streger, Philadelphia, PA (US); Alex Chiu, Baldwin Park, CA (US); Martha Peaseley, Brooklyn, NY (US); Remy Burger, Boulder, CO (US); Chantel Zapata Pray, Easton, MA (US); Prerana Dixit, Longmont, CO (US); Zhila Fahtemeh Emadi, Denver, CO (US); Summer Wang, New York, NY (US)

(21) Appl. No.: 18/986,645

(22) Filed: Dec. 18, 2024

(51) Int. Cl. G06F 16/34; G06F 16/335

(52) U.S. Cl. CPC G06F 16/345; G06F 16/335

(57) ABSTRACT

Methods and systems for caching inputs for an artificial intelligence (AI) model are provided. A request for a summarization of updates to content included in a set of electronic documents is received. An update time window associated with the request is determined based on one or more criteria. One or more portions of the content that were updated during the update time window are identified of the set of electronic documents. The identified one or more portions of the content and the updates to the identified one or more portions of the content are provided as input to an AI model. One or more outputs of the AI model are obtained. The output(s) include the summarization of the updates to the one or more portions of the content. The summarization of the updates to the one or more portions of the content is provided in accordance with the request.

### TECHNICAL FIELD

Aspects and implementations of the present disclosure relate to methods and systems for summarizing updates to electronic documents using artificial intelligence (AI).

### BACKGROUND

The development and deployment of artificial intelligence (e.g., large language models (LLMs) has revolutionized various industries by enabling highly sophisticated natural language processing capabilities. Artificial intelligence (AI) models are trained on vast datasets and possess the ability to generate human-like text and provide informative responses to user queries.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving a request for a summarization of updates to content included in a set of electronic documents. The method further includes determining, based on one or more criteria, an update time window associated with the request. The method further includes identifying, of the set of electronic documents, one or more portions of the content that were updated during the update time window. The method further includes providing the identified one or more portions of the content and the updates to the identified one or more portions of the content as input to an artificial intelligence (AI) model. The method further includes obtaining one or more outputs of the AI model. The one or more outputs include the summarization of the updates to the one or more portions of the content. The method further includes providing the summarization of the updates to the one or more portions of the content in accordance with the request.

In some implementations, the request for the summarization of the updates to the content is a current request received during a current time period. The one or more criteria pertain to a predefined time window length for requests of a particular type. Determining the update time window associated with the request includes determining that a request type of the request corresponds to summarization of updates to content. The method further includes identifying a pre-defined time window length for the request type corresponding to the summarization of updates to content. The method further includes determining an initial time period of the update time window based on the pre-defined time window length. A final time period of the update time window includes the current time period.

In some implementations, the request for the summarization of the updates to the content is a current request received during a current time period. The one or more criteria pertain to a time of a prior request of a particular type. Determining the update time window associated with the request includes determining that a request type of the request corresponds to summarization of updates to content. The method further includes determining that a prior request of the request type corresponding to the summarization of updates to content was received during a prior time period from a client device associated with the current request. The method further includes determining that an initial time period of the update time window includes the prior time period and a final time period of the update time window includes the current time period.

In some implementations, the method further includes, responsive to receiving an additional request from an additional client device for the summarization of updates to the content included in the set of electronic documents, determining an additional update time window associated with the additional request. The additional update time window is different from the update time window. The method further includes identifying, of the set of electronic documents, one or more additional portions of the content that were updated during the additional update time window. The method further includes providing the identified one or more additional portions of the content and the updates to the identified one or more additional portions of the content as input to the AI model. The method further includes obtaining one or more outputs of the AI model including the summarization of the updates to the identified one or more additional portions of the content. The summarization of the updates to the identified one or more additional portions of the content is different from the summarization of the updates to the one or more portions of the content.

In some implementations, the request for the summarization of the updates to the content includes an indication of a particular topic associated with the content. The method further includes identifying the set of electronic documents of multiple electronic documents of a platform as including the content associated with the particular topic.

In some implementations, the updates to the identified one or more portions of the content include at least one of a modification of a content item of the one or more portions of the content, a deletion of the content item, an annotation of the content item, an addition of an additional content item to the identified one or more portions of the content, or a comment associated with at least one of the content item or the additional content item.

In some implementations, the summarization of the updates to the one or more portions of the content reflects one or more of a prior state of the content before the update, or a current state of the content after the update.

In some implementations, the method further includes providing a user interface (UI) for presentation to a user of a client device. The UI includes one or more UI elements associated with obtaining the summarization of updates to content included in the set of electronic documents The request for the summarization of the updates to the content is received responsive to a user selection of at least one of the one or more UI elements.

In some implementations, the summarization of the updates includes an indication of one or more action items associated with a user associated with the set of electronic documents.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example predictive system, and an example query engine, in accordance with implementations of the present disclosure.

FIG. 3 depicts a flow diagram of an example method for caching query responses of an artificial intelligence (AI) model, in accordance with implementations of the present disclosure.

FIGS. 4A-4B depict examples of caching query responses of an AI model, in accordance with implementations of the present disclosure.

FIG. 5 is a block diagram illustrating an exemplary computer system, in accordance with implementations of the present disclosure.

### DETAILED DESCRIPTION

Aspects of the present disclosure relate to summarizing updates to electronic documents using artificial intelligence (AI). A platform can provide users with access to tools or functionalities that enable the users to collaborate on one or more electronic documents (e.g., word documents, spreadsheet documents, slide presentation documents, etc.) and/or communicate with other users via messaging tools (e.g., electronic mail (e-mail) tools, chat messaging tools, etc.). For example, multiple users of the platform may be part of a team or group that works together on a common project or initiative. The platform may provide such users with tools or functionalities that enable the users to collaborate on documents pertaining to the project or initiative and/or communicate via messages on the project or initiative.

Some projects or initiatives can be associated with a significantly large number of electronic documents or messages, which may be frequently updated by users. In light of this, it can be difficult for a respective user to understand the state of a project or initiative at any given time. In conventional systems, a user that wishes to understand the current state and/or most recent updates of a project or initiative accesses each electronic document or message associated with the project to attempt to ascertain updates to the project (e.g., since the last time period the user accessed the electronic document or message). As some projects or initiatives can be associated with a significantly large number of documents and/or messages, it can take the user a significant amount of time to review each document and understand the changes and/or updates. Further, as some projects or initiatives may involve many different aspects, each of which are associated with a respective set of documents or messages, it may be difficult for the user to track changes or identify the most relevant information for each aspect of the project or initiative, across each set of documents. For example, documents associated with a marketing campaign project may include a first set of documents associated with a timeline for the marketing campaign and a second set of documents associated with a budget for the marketing campaign. The first set of documents may use terminology, formats, or levels of detail that is different from that of the second set of documents, making it difficult for the user to identify the most relevant information and/or fully understand the state of each respective aspect of the marketing campaign (e.g., relative to other aspects of the marketing campaign).

Accessing a large number of electronic documents can take a significant amount of time, which can consume a significant amount of computing resources (e.g., processing cycles, memory space, etc.). Such computing resources are made unavailable to other processes, which decreases the overall efficiency and increases the overall latency of the system. If the user is unable to ascertain the state of the project based on their review of the large number of documents, such computing resources are wasted, further impacting the overall efficiency and overall latency of the system. Finally, in some instances, a user that is unable to ascertain the state of a project or initiative may send messages asking other users associated with the project or initiative of the current state. Transmittal of such messages may impact overall network bandwidth of the system and may impact user workflow.

Implementations of the present disclosure address the above and other deficiencies by providing methods and systems for summarizing updates to content in electronic documents using artificial intelligence (AI). A platform can provide a user interface (UI) to client device(s) associated with users of the platform, the UI including one or more UI elements that enable the users to access electronic documents associated with the platform. In accordance with embodiments described herein, an electronic document can include a word document, a spreadsheet document, a slide presentation document, or a message document (e.g., a file including content of one or more messages between users of the platform). In some embodiments, the electronic documents are associated with a project and/or initiative of a set of users of the platform. For purposes of example and illustration only, some embodiments and examples are described with respect to a marketing campaign project associated with a set of users of the platform. However, embodiments of the present disclosure can be applied to any type of project or initiative and/or any type of electronic document or message (e.g., including documents or messages that are not associated with a particular project or initiative). In some embodiments, users may update the electronic documents associated with the project or initiative and/or communicate updates to the project or initiative over messaging tools of the platform.

In some embodiments, the UI can include a UI element that enables a user to request a summarization of updates to content included in a set of electronic documents. The UI element can be a button element or a text box element, in some embodiments. Upon detection of a user engaging with the UI element, the client device of the user can transmit the request for summarization of the updates to content included in the electronic documents to the platform. Upon receiving the request, the platform can determine an update time window associated with the request, where updates made to electronic documents during the update time window are to be summarized in accordance with the request. The update time window can include an initial time period and a final time period, where the final time period corresponds to a current time period (e.g., a time period when the request is received) and the initial time period is a prior time period.

The platform can determine the initial time period (e.g., and therefore the update time window) based on one or more criteria, in some embodiments. In some embodiments, the one or more criteria can pertain to a pre-defined time window length for requests of a particular type (e.g., requests for a summarization of updates). The pre-defined time window length can be provided by a developer or operator of the platform, in some embodiments. The platform can determine the initial time period of the update time window based on the pre-defined time window length and the final time period, in some embodiments. In an illustrative example, the request may be received at time t0 and the pre-defined time window length may be seven days. Accordingly, the platform can determine the initial time period is seven days prior to time t0 and the final time period is time t0. In other or similar embodiments, the one or more criteria pertain to a time of a prior request of the particular type (e.g., requests for summarization of updates, requests to access the set of electronic documents, etc.). For example, the platform can determine a prior time period when a request for summarization of updates and/or a request to access the set of electronic documents is received from the client device associated with the user. The initial time period of the update time window can include the determined prior time period and the final time period of the update time window can include the current time period, as described above.

Upon determining the update time window associated with the request, the platform can identify, of the set of electronic documents, one or more portions of content that were updated during the update time window. An update to a portion of content can include adding new content to the portion of content, modifying existing content of the portion of content, removing existing content of the portion of content, annotating existing content of the portion of content, adding or updating a comment pertaining to existing content of the portion of content, and so forth. The platform can provide the identified one or more portions of the content and/or the updates to the identified one or more portions of the content as an input to an AI model. The AI model may be trained to perform tasks associated with the platform. For example, the AI model can be trained to perform tasks such as content generation, content summarization, content expansion, data classification, knowledge retrieval, and so forth, as well as performing operations on behalf of a requesting user (e.g., creating a calendar invitation, generating and transmitting an electronic message, etc.). The platform can obtain one or more outputs of the AI model, which can include the summarization of the updates to the one or more portions of the content. In an illustrative example, the one or more outputs can include the summarization of the updates made to the electronic documents and/or messages associated with the marketing campaign project. The platform can provide the summarization of the updates to the portion(s) of the content for presentation to the user of the client device, in accordance with the request.

Aspects of the present disclosure provide techniques for obtaining a summarization of updates to content of electronic documents using AI. As described above, embodiments of the present disclosure enable a user to request a summarization of updates to electronic documents of a platform. Accordingly, a user can ascertain updates to the electronic documents without accessing and reviewing the content of each electronic document, which reduces the amount of computing resources (e.g., processing cycles, memory space, etc.) consumed by the system. Therefore, such computing resources are made available for other processes of the system, which improves the overall efficiency and reduces the overall latency of the system. Further, as users are able to obtain a summarization of updates to content, users do not send messages asking other users associated with the electronic document of the current state, therefore reducing the overall number of messages transmitted between client devices, thus improving overall network bandwidth of the system and enhancing user workflow.

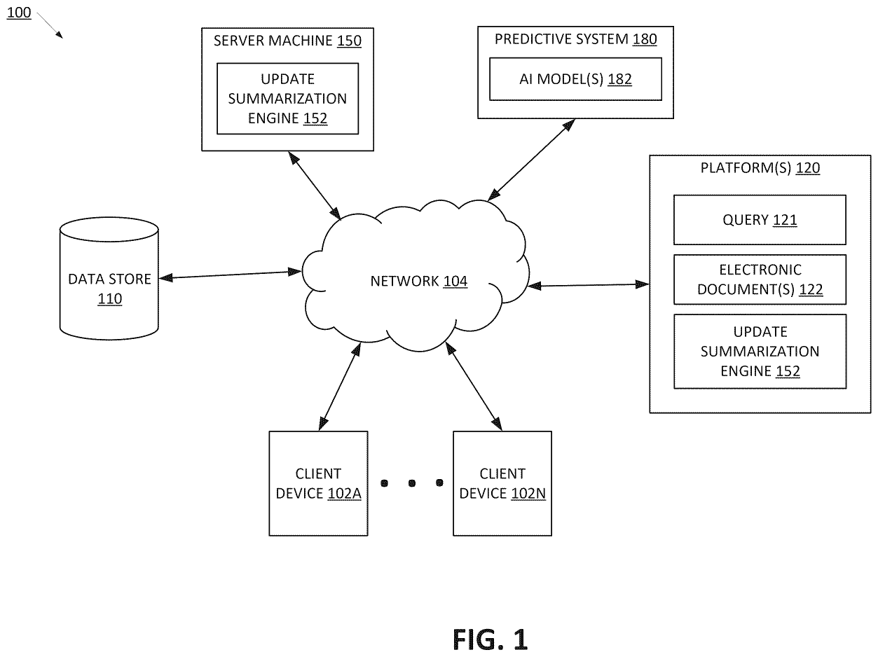

FIG. 1 illustrates an example system architecture 100, in accordance with implementations of the present disclosure. The system architecture 100 (also referred to as “system” herein) includes one or more client devices 102A-N, a data store 110, a platform 120 (e.g., a collaborative document platform, a productivity platform, etc.), one or more server machines (e.g., server machine 150), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data can include (or include data of) one or more electronic documents and/or metadata associated with the one or more electronic documents, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines (e.g., server machine 150) coupled to the platform 120 via network 104.

Client devices 102A-N (collectively and individually referred to as client device(s) 102 herein). can include one or more computing devices such as personal computers (PCs), laptops, mobile phones, smart phones, tablet computers, netbook computers, network-connected televisions, etc. In some implementations, a client device 102 can also be referred to as a “user device.” Client devices 102 can include a content viewer. In some implementations, a content viewer can be an application that provides a user interface (UI) for users to view or upload content, such as images, media items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital media items, digital images, electronic books, etc.). In some implementations, the content viewer can be an electronic document platform application for users to generate, edit, and/or upload content for electronic documents on the platform 120. In other or similar implementations, the content viewer can be an electronic messaging platform application (e.g., an electronic mail (e-mail) application) for users to generate and send messages via platform 120. As such, the content viewers can be provided to the client devices 102A-102N by platform 120.

In some implementations, platform 120 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file (e.g., an electronic document, an e-mail message, etc.) and/or provide the file to the user. For example, platform 120 can be an electronic document platform, such as a collaborative document platform or a productivity platform. The electronic document platform may allow a user to create, edit (e.g., collaboratively with other users), access or share with other users an electronic document stored at data store 110. In another example, platform 120 can allow a user to create, edit, or access electronic messages (e.g., e-mails) addressed to other users of the electronic messaging platform or users of client devices outside of the electronic messaging platform. Platform 120 can also include a website (e.g., a webpage) or application back-end software that can be used to provide a user with access to files.

As described above, platform 120 can provide users with access to one or more electronic communication services that enable users to correspond with other users of platform 120 and/or non-users of platform 120. An electronic communication service includes any service that enables the transmission of electronic message(s) between client devices 102 of system 100 or of other client devices of another system. In some embodiments, the electronic communication service can include an electronic mail (e-mail) communication service, a chat message communication service, and so forth. It should be noted that although some embodiments herein are described with respect to e-mail communication and chat messaging communication, such embodiments can be applied to any type of communication between users and/or between client devices 102 of users. For example, electronic message(s) can include e-mail messages, chat messages (e.g., instant messages), comment messages associated with an electronic document associated with the platform 120 and/or users of the platform 120, messages transmitted during a virtual meeting hosted by the platform 120, messages and/or information associated with tasks or calendar events associated with users of the platform 120, and so forth.

In some embodiments, functionalities of platform 120 can be supported by one or more AI models 182 (collectively and individually referred to as AI models 182 or AI model 182 herein) provided by predictive system 180. An AI model 182 can be trained to perform multiple types of tasks pertaining to the functionalities of platform 120 and/or files of platform 120. Such tasks include, but are not limited to, content generation, content summarization, content expansion, data classification, knowledge retrieval, and so forth, as well as performing operations on behalf of a requesting user (e.g., creating a calendar invitation, generating and transmitting an electronic message, etc.). A user of platform 120 can access the AI model(s) 182 of predictive system 180 via one or more tools or resources of platform 120. For example, platform 120 can provide a client device 102 associated with a user with access to a user interface (UI) for an application that enables a user to create and/or edit a collaborative electronic document (e.g., a collaborative word document, a collaborative spreadsheet document, a collaborative slide presentation document, etc.). The UI can include one or more UI elements that enable the user to engage with the AI model(s) 182 of predictive system 180 in accordance with the functionality of the application. For instance, the UI can include a UI element that enables a user to request generated content from the AI model(s) 182. Such request can include or otherwise correspond to a query 121 for AI model(s) 182. Upon detecting a user engagement with the UI element (e.g., via a UI of the client device 102), the platform can provide the query 121 to predictive system 180. Predictive system 180 can provide a prompt associated with the query 121 as an input to the AI model(s) 182 and can obtain an output of the model(s), which can include generated content, in accordance with the example. A prompt refers to a natural language text that requests the AI model(s) 182 to perform a specific tasks. In some embodiments, a prompt can include the query 121 provided by the user and/or can include additional or alternative information associated with the query 121 provided by the user. Platform 120 can update the UI provided to the client device 102 to include the generated content for presentation to the user. It should be noted that embodiments of the present disclosure are not limited to the tasks or functions explicitly described herein (e.g., content generation, content summarization, etc.) and embodiments can be applied to any type of task or function that could be performed by an AI model.

In some embodiments, AI model 182 can be an AI model that has been trained on a corpus of textual data. In some embodiments, the AI model 182 can be a model that is first pre-trained on a corpus of text to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 182 can then be further trained and/or fine-tuned on organizational data, including proprietary organizational data. The AI model 182 can also be further trained and/or fine-tuned on organizational data associated with a file, including proprietary organizational data associated with a file.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 182 while training may be ranked by a user, according to a variety of factors, including accuracy, helpfulness, veracity, acceptability, or any other metric useful in the fine-tuning portion of training. In this manner, the AI model 182 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 182 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 182 may be one or more of decision trees, random forests, support vector machines, or other types of machine learning models. In one embodiment, the AI model 145 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 182 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 182 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

As described above, platform 120 can provide users with access to tools and/or functionalities that enable users to collaborate on electronic documents 122 and/or communicate via messaging tools (e.g., e-mail messaging tools, chat messaging tools, etc.). In some embodiments, a set of electronic documents 122 and/or messages can correspond to or otherwise be associated with a project and/or initiative of multiple users of platform 120. In an illustrative example, a group of users of platform 120 may be associated with a marketing team of an organization or entity and may be collaborating on a marketing campaign project. As multiple users may collaborate on the same electronic documents 122, there may be multiple updates by users and/or messages sent between users through the duration of the project and/or initiative. As illustrated in FIG. 1, platform 120 can include an update summarization engine 152, which can provide users with access to a summarization of updates to content of electronic documents and/or messages. In some embodiments, update summarization engine 152 may provide a summarization of updates made to electronic documents 122 within an update time window, as described herein.

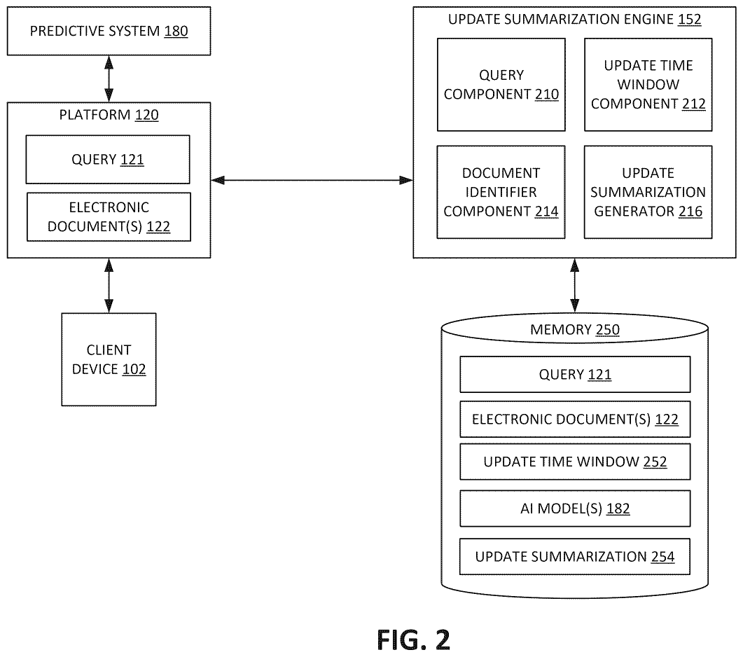

It should be noted that although some embodiments and examples refer to electronic documents, such electronic documents can include or otherwise correspond to messages transmitted between users. As described herein, electronic documents 122 can include, but are not limited to, word documents, spreadsheet documents, slide presentation documents, webpage documents, messaging documents, and so forth. Further details regarding update summarization engine 152 are provided herein with respect to FIGS. 2-4B.

It should be noted that although FIG. 1 illustrates update summary engine 152 as part of platform 120, in additional or alternative embodiments, one or more portions or components of update summary engine 152 can reside and/or be executed at client device(s) 102. In other or similar embodiments, one or more components of update summary engine 152 can reside on one or more server machines that are remote from platform 120. In an illustrative example, update summary engine 152 can reside at server machine 150. It should be noted that in some other implementations, the functions of platform 120, server machine 150, and/or predictive system 180 can be provided by more or a fewer number of machines. For example, in some implementations, components and/or modules of platform 120, server machine 150, and/or predictive system 180 may be integrated into a single machine, while in other implementations components and/or modules of any of platform 120, server machine 150, and/or predictive system 180 may be integrated into multiple machines. In addition, in some implementations, components and/or modules of server machine 150, server machine 160, and/or predictive system 180 may be integrated into platform 120.

In general, functions described in implementations as being performed platform 120, server machine 150, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, an example predictive system 180, and an example update summary engine 152, in accordance with implementations of the present disclosure. As described above, platform 120 can provide users with access to one or more electronic communication services, such as an e-mail service, a chat message service, etc., which involves the transmission of electronic messages between two or more client devices 102 of system 100 (e.g., client device 102A and client device 102B). In other or similar embodiments, platform 120 can provide users with access to electronic documents and/or tools to create and/or edit electronic documents. As described above, one or more AI model(s) 182 (e.g., associated with predictive system 180) can perform operations associated with functionalities or services associated with platform 120. Such operations can include, but are not limited to, a content generation operation, a content augmentation operation, a content summarization operation, a content expansion operation, a data classification operation, a knowledge inquiry operation, a data conversion operation, a program task operation, and so forth. A client device 102 can provide a request to perform an operation associated with AI model(s) 182, as described herein. Such request can include or otherwise correspond to a query 121.

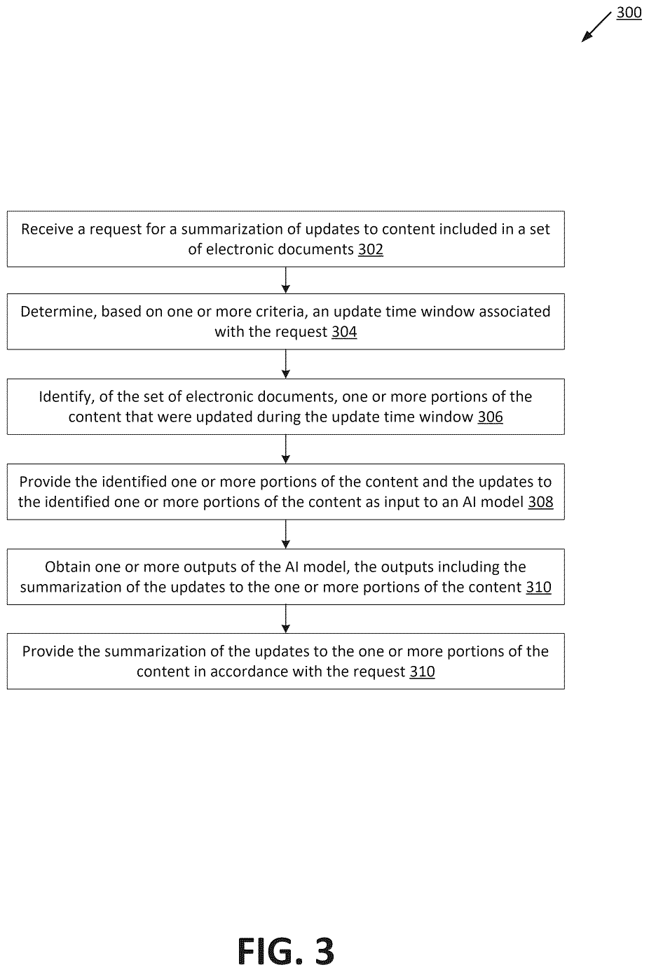

As described above, one or more electronic documents 122 (e.g., word documents, spreadsheet documents, slide presentation documents, messaging documents, etc.) can be associated with a project or initiative of users of platform 120. The users may make updates and/or additions to the documents throughout the duration of the project and/or initiative. As described herein, update summarization engine 152 can provide users with access to a summarization of updates to the electronic documents within an update time window. As illustrated by FIG. 2, update summarization engine 152 can include a query component 210, an update time window component 212, a document identifier component 214, and/or an update summarization generator 216. Details regarding update summarization engine 152 are provided herein with respect to FIG. 2 and FIG. 3 below. As illustrated by FIG. 2, platform 120, update summarization engine 152, and/or predictive system 180 can be connected to memory 250 (e.g., via network 104, via a bus, etc.). Memory 250 can include one or more portions of data store 110, in some embodiments. In other or similar embodiments, memory 250 can include or correspond to any memory of any component of system 100 and/or otherwise accessible to a component of system 100.

FIG. 3 depicts a flow diagram of an example method 300 for summarizing updates to electronic documents using artificial intelligence (AI), in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by update summarization engine 152.

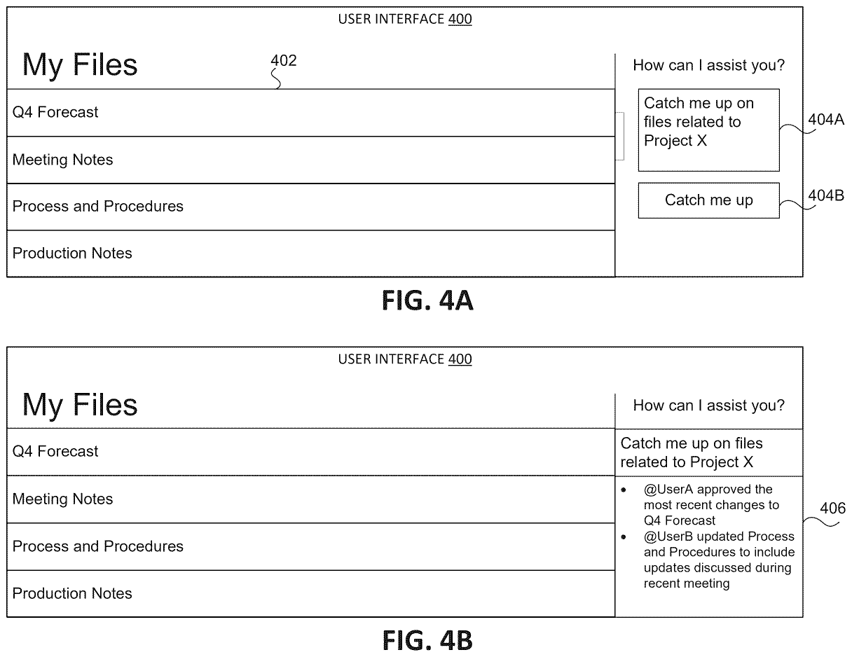

At block 302, processing logic receives a request for a summarization of updates to content included in a set of electronic documents. As described above, platform 120 can provide users with access to electronic documents 122 (e.g., word documents, spreadsheet documents, slide presentation documents, messaging documents, etc.) via a UI of a client device 102 associated with such users. FIG. 4A illustrates an example UI 400, in accordance with embodiments and implementations herein. As illustrated in FIG. 4A, UI 400 can include a first portion that includes one or more UI elements 402 associated with electronic documents 122. For example, the first portion of UI 400 can include a UI element 402 associated with an electronic document 122 titled “Q4 Forecast,” a UI element 402 associated with an electronic document 122 titled “Meeting Notes,” a UI element 402 associated with an electronic document 122 titled “Process and Procedures,” and/or a UI element 402 associated with an electronic document 122 titled “Production Notes.” In some embodiments, the electronic document(s) 122 can be associated with multiple users of platform 120. In additional or alternative embodiments, the electronic document(s) 122 can be associated with a project or initiative of the multiple users.

As illustrated in FIG. 4A, UI 400 can include a second portion that includes one or more UI elements 404 that enable a user to request a summarization of updates to documents 122. In some embodiments, the one or more UI elements 404 can include a text box UI element 404A that enables the user to provide a customized, text-based query. For example, as illustrated in FIG. 4A, a user can provide the text-based query of “Catch me up on files related to Project X” via text box UI element 404A. In other or similar embodiments, the one or more UI elements 404 can include a button UI element 404B that is associated with obtaining a summarization of updates to electronic document(s) 122. For example, a user can engage with button UI element 404B to initiate a query 121 to obtain a summarization of updates to electronic document(s) 122.

In some embodiments, the request for a summarization of updates to content of electronic document(s) 122 can include an indication of a type of electronic documents 122 that are impacted by the request. As described above, UI element 404A can be a text box UI element 404 that enables the user to provide a customized, text-based query. The user-provided query can indicate particular documents 122 that are invoked or impacted by the request for summarization of updates, in some embodiments. For example, the user-provided query 121 can include a request to “Catch me up on the Q4 forecast and Meeting Notes files,” where updates to content of the electronic documents 122 titled “Q4 forecast” and “Meeting Notes” are to be summarized, in accordance with the request. In other or similar embodiments, the user-provided query can indicate a type of documents 122 that are invoked or impacted by the request for summarization of updates. For example, as illustrated in FIG. 4, the user-provided query 121 can include a request to “Catch me up on files related to Project X,” where updates to content of the electronic documents 122 including content related to “Project X” are to be summarized, in accordance with the request. As will be seen below, update summarization engine 152 can identify electronic documents 122 that are associated with “Project X,” in such embodiments.

As described above, the user may initiate the request for the summarization of updates to electronic document(s) 122 by engaging with button UI element 404B. In such embodiments, the user may be unable to specify the specific document(s) 122 or types of document(s) 122 that are subject to the request. In some embodiments, the client device 102 can transmit an indication of one or more electronic documents 122 that are indicated by the UI elements 402 when the user engages with the UI element 404B with the query 121. For example, each electronic document 122 indicated by UI elements 402 of UI 400 can be included in a folder or other type organization structure associated with platform 120. Upon detection of a user engagement of the UI element 404B, client device 102 can include an indication of the electronic documents 122 associated with UI elements 402 and/or other electronic documents 122 included in the folder or other type of organization structure (e.g., which may not be associated with a UI element 402 of UI 400, as displayed to the user when the UI element 404B is selected).

Upon detection of a user engagement with a UI element 404 (e.g., UI element 404A and/or UI element 404B), the client device 102 can transmit the request (and/or the query 121 associated with the request) to platform 120 (e.g., via network 104). As described above, the request (and/or query 121) may include an indication of electronic documents 122 that are involved with the query 121 and/or an indication of a type of electronic documents 122 that are involved with the query 121.

Referring back to FIG. 3, at block 304, processing logic determines, based on one or more criteria, an update time window associated with the request. An update time window 252 refers to a time window during which updates to electronic documents 122 involved or otherwise associated with the query 121 are to be summarized, in accordance with the query 121. In some embodiments, the one or more criteria can pertain to a pre-defined time window length for requests of a particular type (e.g., requests for a summarization of updates to content). The pre-defined time window length can be provided by a developer or operator of platform 120, in some embodiments. In other or similar embodiments, the pre-defined time window length can be determined based on historical data or experimental data associated with platform 120. For example, platform 120 can collect historical or experimental data representing a frequency that users access electronic documents 122 associated with a common project or initiative. Platform 120 can determine the predefined time window length, which represents an aggregate (e.g., an average, etc.) amount of time between access to the electronic documents 122 based on the collected historical data or experimental data.

In such embodiments, update time window component 212 can determine the request type associated with query 121 is an update summarization request and, based on the determination, identify the pre-defined time window length for updates summarization requests. Update time window component 212 can determine an initial time period of the update time window 252 and a final time period of the update time window 252. In some embodiments, the final time period of the update time window 252 can include the current time period (e.g., the time period during which the request and/or query 121 is received) and the initial time period of the update time window 252 can include a time period that has a distance of the pre-defined time window length from the final time period of the update time window 252. In an illustrative example, the pre-defined time window length can be 7 days. The final time period of the update time window 252 can include the current time period and the initial time period of the update time window 252 can be a time period that is 7 days prior to the final time period.

In other or similar embodiments, the one or more criteria can pertain to a time of a prior request of the particular type (e.g., requests for a summarization of updates made to content of electronic documents). The prior request may be received from the client device 102 that transmitted the request associated with the query 121, in some embodiments. In some embodiments, update time window component 212 can determine that the request type of the request corresponds to a summarization of updates to content and can determine whether a prior request of the request type was received during a prior time period from a client device 102 associated with the current request. Update time window component 212 can determine whether the prior request of the request type was received during the prior time period from the client device 102 by accessing account data associated with the client device 102 (e.g., at memory 250, at data store 110). For example, account data associated with client device 102 can include a request history indicating one or more requests previously received from client device 102 and a time period during which a respective request was received. Update time window component 212 can access the request history of the account data and determine whether the request history includes a request having the request type of the request associated with query 121. Upon determining that the request history includes a request having the request type, update time window component 212 can determine the time period when the request was received. If update time window component 212 determines that the request history includes multiple requests having the request type, update time window component 212 can identify the request that was most recently received and can determine the time period of when such request was received. In some embodiments, update time window component 212 can determine the initial time period of the update time window 252 and the final time period of the update time window 252, as described above. The final time period of the update time window 252 can include the current time period and the initial time period can include the time period of the prior request.

At block 306, processing logic identifies, of the set of electronic documents, one or more portions of content that were updated during the update time window. An update can include a modification to a content item of the one or more portions of the content, a deletion of a content item, an annotation of a content item, an addition of new content at the one or more portions of the content, a comment associated with a content item, and so forth. As described above, in some embodiments, the request associated with query 121 can include an indication of the electronic documents 122 implicated by the request. In other or similar embodiments, the request can include an indication of a folder or other such organizational structure that includes electronic documents 122 implicated by the request. In such embodiments, document identifier component 214 can identify the electronic documents 122 indicated by the request (e.g., at memory 250, at data store 110, etc.) and/or included in the folder or other such organizational structure and can determine whether one or more of the electronic document(s) 122 were updated within the update time window 252. In some embodiments, document identifier component 214 can determine whether an electronic document 122 was updated based on metadata associated with the electronic document 122. Upon determining that an electronic document 122 was updated within the update time window 252, document identifier component 214 can determine the portions of the electronic document 122 that were updated within the update time window 252. In some embodiments, document identifier component 214 can determine a portion of an electronic document 122 that was updated by comparing a current version of the electronic document 122 with a prior version of the electronic document 122. In other or similar embodiments, document identifier component 214 can determine the portions of the electronic document 122 that were updated based on metadata associated with the electronic document 122. In some embodiments, document identifier component 214 can determine that one or more portions of the electronic document 122 have been updated multiple times during the update time window 252. In such embodiments, document identifier component 214 can determine most recent updates to the portion of the electronic document 122 and/or can identify each update made during the update time window 252.

As described above, in some embodiments, the request associated with query 121 can include an indication of a type of documents 122 implicated by the request. Document identifier component 214 can identify, of memory 250 and/or data store 112, document 122 including content corresponding to the indicated type of documents 122. In some embodiments, document identifier component 214 can determine that a document 122 includes content corresponding to the indicated type of documents 122 based on metadata associated with the documents 122 (e.g., a title of the document 122, a caption or description of the document 122, etc.). In other or similar embodiments, document identifier component 214 can provide a prompt associated with the type of documents 122 as an input to an AI model (e.g., AI model 182 or another AI model) and can obtain one or more outputs of the AI model, which indicate one or more documents 122 including content corresponding to the indicated type of documents 122. Upon identifying the document 122 including content corresponding to the indicated type of documents 122, document identifier component 214 can identify the one or more portions of the content that were updated during the update time window 252, in accordance with previously described embodiments.

At block 308, processing logic provides the identified one or more portions of the content and the updates to the identified one or more portions of the content as input to an AI model. In some embodiments, the AI model 182 can include a general purpose model that is trained to perform multiple different tasks, including, but not limited to, content generation, content summarization, knowledge retrieval, etc. In such embodiments, update summarization generator 216 can also provide a prompt as an input to AI model 182 including instructions to generate the summarization of the updates to the identified one or more portions of content. In other or similar embodiments, the AI model 182 can be a specific purpose model that is trained to perform a specific task (e.g., content summarization). Update summarization generator 216 can provide the identified one or more portions of the content and the updates to the identified portions of the content as an input to the AI model 182. A portion of content that is subject to an update can include content items that are updated (e.g., added, modified, removed, annotated, etc.) and/or additional content items that are located proximate to (e.g., adjacent to, approximately adjacent to) or are related to content items that are updated. In an illustrative example, content items that are updated can reference a timeline for a marketing campaign and additional related content items can reference details for each portion on the timeline for the marketing campaign. In other or similar embodiments, update summarization generator 216 can provide an entire document 122 as an input to the AI model 182 (e.g., which reflects the content subject to the updates and the updates).

At block 310, processing logic obtains one or more outputs of the AI model, the outputs including the summarization of the updates to the one or more portions of the content. In some embodiments, the summarization of the updates (e.g., update summarization 254 of FIG. 2) can reflect a prior state of the content before the update and/or the current state of the content before the update. At block 312, processing logic provides the summarization of the updates to the one or more portions of the content in accordance with the request. As illustrated by FIG. 4B, update summarization engine 152 can update the UI 400 at client device 102 to include the update summarization 254 obtained based on one or more outputs of AI model 182. In some embodiments, updates summarization 254 can indicate the update made to the content of electronic document(s) 122 during the update time window 252, an indication of a user that made the update to the content, a date or time when the update was made, and so forth. For example, based on the user query 121 of “Catch me up on files related to Project X,” update summarization engine 152 can update the UI 400 of client device 102 to include update summarization 254, which can include an indication that “@UserA approved the most recent changes to Q4 Forecast” and/or “@UserB updated Process and Procedures to include updates discussed during a recent meeting.” It should be noted that although FIG. 4B depicts update summarization 254 as included in the second portion of UI 400, update summarization 254 can be included in other portions of UI 400, in accordance with embodiments of the present disclosure.

In some embodiments, update summarization engine 152 can obtain updates summarization 254 based on additional or alternative data or information. For example, based on a request for a summarization of updates to electronic document(s) 122 associated with “Project X” from client device 102, document identifier component 214 can identify additional data or information associated with client device 102 and/or a user of client device 102 that pertains to “Project X.” Such additional data or information can include calendar events or invitations that reference “Project X,” as well as additional information, for example. In other or similar embodiments, document identifier component 214 may identify additional data or information that pertains to “Project X,” from a data store that stores data associated with multiple different projects, topics, initiatives, etc. Such data store can include a publicly accessible data store, a private data store, a data store associated with a particular organization or entity (e.g., that is made available to users associated with the organization or entity and/or licensees or subscribers of the organization or entity), and so forth. In some embodiments, AI model 182 may generate update summarization 254 based on the additional data or information (e.g., associated with client device 102 and/or the user, obtained from the data store, etc.). In an illustrative example, the generated update summarization 254 may indicate that “Phase A of Project X is put on hold until Component B is confirmed,” based on information ascertained from updates made to content of an electronic document 122. Generated update summarization 254 may further indicate that “Component B is to be discussed during Client Meeting on January 10,” based on a calendar event and/or invitation that references “Project X.” In another illustrative example, the generated update summarization 254 may indicate that “Budget team is waiting to finalize the proposal until Q1 financial report is available,” based on updates to content of electronic document(s) 122. The generated update summarization 254 may further indicate that “Q1 financial report is available at organization data store,” based on information obtained from the organization data store.

In other or similar embodiments, update summarization 254 can include one or more action items that are associated with the user that initiated the request associated with query 121 and/or other users associated with electronic document(s) 122 and/or the project or initiative of electronic document(s) 122. In some embodiments, update summarization generator 216 can provide an identifier for a user of the client device 102 that provided the request as an input to AI model 182 (e.g., with the portion(s) of content and/or updates to the portion(s) of content), which can cause AI model 182 to generate the one or more action items associated with the user. In other or similar embodiments, the one or more outputs of the AI model 182 can include action items associated with each user referenced by the content of the electronic documents and/or updates to the content of the electronic documents. Update summarization generator 216 can identify the action items of the one or more outputs that pertain to the user of the client device 102 that initiated the request and include the identified action items in update summarization 254, in some embodiments. In other or similar embodiments, update summarization generator 216 can include the action items of the other users in update summarization 254.

In yet additional or alternative embodiments, update summarization generator 216 can provide additional information pertaining to the user of the client device 102 that initiated the request associated with query 121 as an input to AI model 182. Such information can cause AI model 182 to customize update summarization 254 based on the provided additional information. In an illustrative example, update summarization generator 216 can provide information associated with a team or a group associated with the user, and/or a role of the user within the team or group, as an input to AI model 182 (e.g., with the portion(s) of content and/or updates to the portion(s) of content). The updates summarization 254 can include a summarization of updates specific to such team or group and/or specific to the role of the user, based on the provided information. For instance, upon providing an indication that a user is an entry level employee of the team, updates summarization 254 may include a summarization of updates and/or action items pertaining to content that is specific to the user's role on the team. In another instance, upon providing an indication that a user is a manager of the team, updates summarization 254 may include a summarization of updates and/or action items pertaining to each team member and/or key milestones associated with the project or initiative (e.g., as indicated by content of electronic document(s) 122).

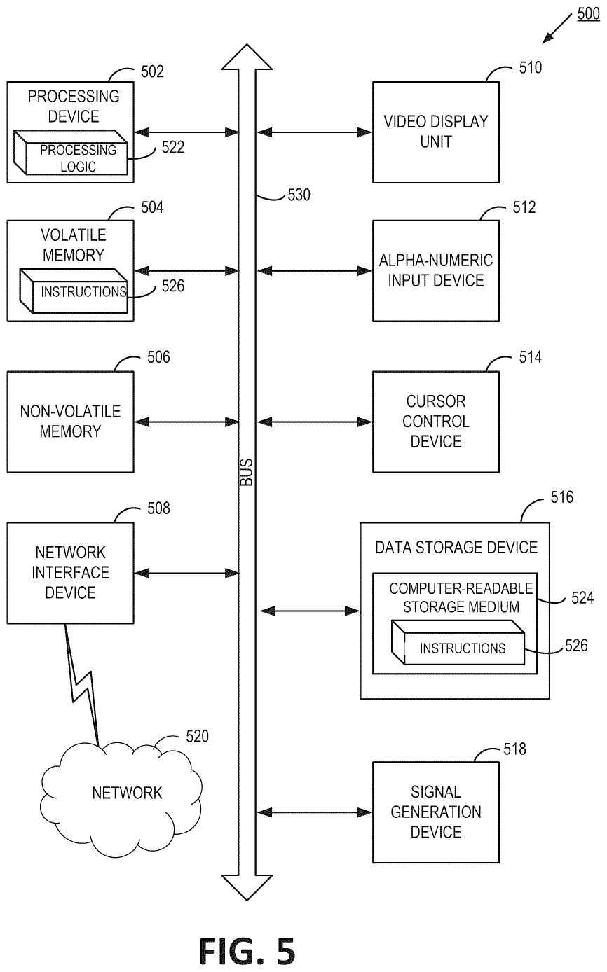

FIG. 5 is a block diagram illustrating an exemplary computer system 500, in accordance with implementations of the present disclosure. The computer system 500 can correspond to platform 120, client devices 52A-N, server machine 150, and/or predictive system 180 described herein and with respect to FIGS. 1-4B. Computer system 500 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 540.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 505 for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 520 (e.g., a speaker).

The data storage device 518 can include a non-transitory machine-readable storage medium 524 (also computer-readable storage medium) on which is stored one or more sets of instructions 505 embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 530 via the network interface device 508.

In one implementation, the instructions 505 include instructions for providing fine-grained version histories of electronic documents at a platform. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving a request for a summarization of updates to content included in a set of electronic documents;
determining, based on one or more criteria, an update time window associated with the request;
identifying, of the set of electronic documents, one or more portions of the content that were updated during the update time window;
providing the identified one or more portions of the content and the updates to the identified one or more portions of the content as input to an artificial intelligence (AI) model;
obtaining one or more outputs of the AI model, wherein the one or more outputs comprise the summarization of the updates to the one or more portions of the content; and
providing the summarization of the updates to the one or more portions of the content in accordance with the request.

2. The method of claim 1, wherein the request for the summarization of the updates to the content is a current request received during a current time period, wherein the one or more criteria pertain to a pre-defined time window length for requests of a particular type, and wherein determining the update time window associated with the request comprises:
determining that a request type of the request corresponds to summarization of updates to content;
identifying a pre-defined time window length for the request type corresponding to the summarization of updates to content; and
determining an initial time period of the update time window based on the pre-defined time window length, wherein a final time period of the update time window comprises the current time period.

3. The method of claim 1, wherein the request for the summarization of the updates to the content is a current request received during a current time period, wherein the one or more criteria pertain to a time of a prior request of a particular type, and wherein determining the update time window associated with the request comprises:
determining that a request type of the request corresponds to summarization of updates to content;
determining that a prior request of the request type corresponding to the summarization of updates to content was received during a prior time period from a client device associated with the current request; and
determining that an initial time period of the update time window comprises the prior time period and a final time period of the update time window comprises the current time period.

4. The method of claim 1, further comprising:
responsive to receiving an additional request from an additional client device for the summarization of updates to the content included in the set of electronic documents, determining an additional update time window associated with the additional request, wherein the additional update time window is different from the update time window;
identifying, of the set of electronic documents, one or more additional portions of the content that were updated during the additional update time window;
providing the identified one or more additional portions of the content and the updates to the identified one or more additional portions of the content as input to the AI model; and
obtaining one or more outputs of the AI model comprising the summarization of the updates to the identified one or more additional portions of the content, wherein the summarization of the updates to the identified one or more additional portions of the content is different from the summarization of the updates to the one or more portions of the content.

5. The method of claim 1, wherein the request for the summarization of the updates to the content comprises an indication of a particular topic associated with the content, and wherein the method further comprises:
identifying the set of electronic documents of a plurality of electronic documents of a platform as comprising the content associated with the particular topic.

6. The method of claim 1, wherein the updates to the identified one or more portions of the content comprise at least one of:
a modification of a content item of the one or more portions of the content,
a deletion of the content item,
an annotation of the content item,
an addition of an additional content item to the identified one or more portions of the content, or
a comment associated with at least one of the content item or the additional content item.

7. The method of claim 1, wherein the summarization of the updates to the one or more portions of the content reflects one or more of a prior state of the content before the update, or a current state of the content after the update.

8. The method of claim 1, further comprising:
providing a user interface (UI) for presentation to a user of a client device, wherein the UI comprises one or more UI elements associated with obtaining the summarization of updates to content included in the set of electronic documents,
wherein the request for the summarization of the updates to the content is received responsive to a user selection of at least one of the one or more UI elements.

9. The method of claim 1, wherein the summarization of the updates comprises an indication of one or more action items associated with a user associated with the set of electronic documents.

10. A system comprising:
a memory; and
a set of one or more processing devices coupled to the memory, wherein the set of one or more processing devices is to perform operations comprising:
receiving a request for a summarization of updates to content included in a set of electronic documents;
determining, based on one or more criteria, an update time window associated with the request;
identifying, of the set of electronic documents, one or more portions of the content that were updated during the update time window;
providing the identified one or more portions of the content and the updates to the identified one or more portions of the content as input to an artificial intelligence (AI) model;
obtaining one or more outputs of the AI model, wherein the one or more outputs comprise the summarization of the updates to the one or more portions of the content; and
providing the summarization of the updates to the one or more portions of the content in accordance with the request.

11. The system of claim 10, wherein the request for the summarization of the updates to the content is a current request received during a current time period, wherein the one or more criteria pertain to a pre-defined time window length for requests of a particular type, and wherein determining the update time window associated with the request comprises:
determining that a request type of the request corresponds to summarization of updates to content;
identifying a pre-defined time window length for the request type corresponding to the summarization of updates to content; and
determining an initial time period of the update time window based on the pre-defined time window length, wherein a final time period of the update time window comprises the current time period.

12. The system of claim 10, wherein the request for the summarization of the updates to the content is a current request received during a current time period, wherein the one or more criteria pertain to a pre-defined time window length for requests of a particular type, and wherein determining the update time window associated with the request comprises:
determining that a request type of the request corresponds to summarization of updates to content;
identifying a pre-defined time window length for the request type corresponding to the summarization of updates to content; and
determining an initial time period of the update time window based on the pre-defined time window length, wherein a final time period of the update time window comprises the current time period.

13. The system of claim 10, wherein the operations further comprise:
responsive to receiving an additional request from an additional client device for the summarization of updates to the content included in the set of electronic documents, determining an additional update time window associated with the additional request, wherein the additional update time window is different from the update time window;
identifying, of the set of electronic documents, one or more additional portions of the content that were updated during the additional update time window;
providing the identified one or more additional portions of the content and the updates to the identified one or more additional portions of the content as input to the AI model; and
obtaining one or more outputs of the AI model comprising the summarization of the updates to the identified one or more additional portions of the content, wherein the summarization of the updates to the identified one or more additional portions of the content is different from the summarization of the updates to the one or more portions of the content.

14. The system of claim 10, wherein the request for the summarization of the updates to the content comprises an indication of a particular topic associated with the content, and wherein the method further comprises:
identifying the set of electronic documents of a plurality of electronic documents of a platform as comprising the content associated with the particular topic.

15. The system of claim 10, wherein the updates to the identified one or more portions of the content comprise at least one of:
a modification of a content item of the one or more portions of the content,
a deletion of the content item,
an annotation of the content item,
an addition of an additional content item to the identified one or more portions of the content, or
a comment associated with at least one of the content item or the additional content item.

16. The system of claim 10, wherein the summarization of the updates to the one or more portions of the content reflects one or more of a prior state of the content before the update, or a current state of the content after the update.

17. The system of claim 10, wherein the operations further comprise:
providing a user interface (UI) for presentation to a user of a client device, wherein the UI comprises one or more UI elements associated with obtaining the summarization of updates to content included in the set of electronic documents,
wherein the request for the summarization of the updates to the content is received responsive to a user selection of at least one of the one or more UI elements.

18. A non-transitory computer readable storage medium comprising instructions that, when executed by a processing device, cause the processing device to perform operations comprising:
receiving a request for a summarization of updates to content included in a set of electronic documents;
determining, based on one or more criteria, an update time window associated with the request;
identifying, of the set of electronic documents, one or more portions of the content that were updated during the update time window;
providing the identified one or more portions of the content and the updates to the identified one or more portions of the content as input to an artificial intelligence (AI) model;
obtaining one or more outputs of the AI model, wherein the one or more outputs comprise the summarization of the updates to the one or more portions of the content; and
providing the summarization of the updates to the one or more portions of the content in accordance with the request.

19. The non-transitory computer readable storage medium of claim 18, wherein the request for the summarization of the updates to the content is a current request received during a current time period, wherein the one or more criteria pertain to a pre-defined time window length for requests of a particular type, and wherein determining the update time window associated with the request comprises:
determining that a request type of the request corresponds to summarization of updates to content;
identifying a pre-defined time window length for the request type corresponding to the summarization of updates to content; and
determining an initial time period of the update time window based on the pre-defined time window length, wherein a final time period of the update time window comprises the current time period.

20. The non-transitory computer readable storage medium of claim 18, wherein the request for the summarization of the updates to the content is a current request received during a current time period, wherein the one or more criteria pertain to a time of a prior request of a particular type, and wherein determining the update time window associated with the request comprises:
determining that a request type of the request corresponds to summarization of updates to content;
determining that a prior request of the request type corresponding to the summarization of updates to content was received during a prior time period from a client device associated with the current request; and
determining that an initial time period of the update time window comprises the prior time period and a final time period of the update time window comprises the current time period.
